(19) United States
(12) Patent Application Publication
(10) Pub. No.: US 2011/0043542 A1
(43) Pub. Date: Feb. 24, 2011

(54) DISPLAY DEVICE

(76) Inventors: Tsuyoshi KASHIWAGI, Tokyo-to (JP); Naoyuki MITSUYASU, Tokyo-to (JP); Yuta SHINTAKU, Tokyo-to (JP)

Correspondence Address: LADAS & PARRY LLP, 224 SOUTH MICHIGAN AVENUE, SUITE 1600, CHICAGO, IL, 60604, US

(21) Appl. No.: 12/829,570

(22) Filed: Jul. 2, 2010

(30) Foreign Application Priority Data
Jul. 6, 2009 (JP) 2009-160189

(51) Int. Cl. G09G 5/10

(52) U.S. Cl. 345/690

(57) ABSTRACT

The present invention provides a display device which can attain higher contrast than that of the conventional display device. The display device (1) comprises: an image light source (2); and an optical sheet (10) having a plurality of layers for controlling an incident light from the image light source and for outputting the light to the observer side, wherein the optical sheet comprises an optical functional sheet layer (12) in which light-transmissive portion(s) (13) configured to transmit light and light-absorbing portion(s) (14) configured to absorb light are alternately arranged along the sheet plane, and only one layer (11) or a plurality of layers of which refractive indices are substantially the same is (are) provided on the observer side of the optical functional sheet layer.

### BACKGROUND OF THE INVENTION

1. Field of the Invention

The present invention relates to a display device comprising an optical sheet which is used for a display device such as a plasma television and which adequately controls an incident light to output to the observer side.

2. Description of the Related Art

In a display device comprising a plasma display panel (hereinafter, referred to as “PDP”.), e.g. the so-called “plasma television”, an optical sheet which is sometimes called “front face filter” is provided on the observer side of the light source such as PDP. The optical sheet is a sheet which controls a light from a light source (image light source) and which has various optical functions for providing an eye-friendly and adequate image light to the observer side.

The optical sheet is formed by laminating a plurality of layers each having a particular function. For example, Patent document 1 (Japanese Patent Application Laid-Open (JP-A) No. 2006-189867) discloses a laminate structure of an optical sheet and states that it is possible to improve transmissivity (brightness) and contrast (light-dark ratio) of the image light by the optical sheet.

### SUMMARY OF THE INVENTION

However, in recent years, because of increasing definition and performance of image displays, further improvement in contrast of the conventional optical sheet such as the one shown in Patent document 1 is required.

Accordingly, an object of the present invention is to provide a display device comprising an optical sheet which can attain high contrast.

As a result of intensive study by the inventors, they discovered that apart of an external light which enters an optical sheet reflects off an interface between layers having a refractive index difference before reaching a light-absorbing layer and returns to the observer side as a reflected light, which results in decrease in contrast. In addition, the inventors discovered that if many interfaces having refractive index difference are arranged in front of the light-absorbing layer, decrease in contrast is significant. According to the discoveries, the inventors completed the present invention. The invention will be described as follows. In order to make the understanding of the present invention easier, reference numerals of the attached drawings are quoted in brackets; however, the present invention is not limited by the embodiments shown in the drawings.

The first aspect of the present invention is a display device (1) comprising: an image light source (2); and an optical sheet (10) having a plurality of layers for controlling an incident light from the image light source and for outputting the light to the observer side, wherein the optical sheet comprises an optical functional sheet layer (12) in which light-transmissive portion(s) (13) configured to transmit light and light-absorbing portion(s) (14) configured to absorb light are alternately arranged along the sheet plane, and only one layer (11) is provided on the observer side of the optical functional sheet layer.

The second aspect of the invention according to the display device (1) of the first aspect of the invention is characterized in that refractive index of the layer laminated on the observer side of the optical functional sheet layer (12) is substantially the same as that of the light-transmissive portion (13) of the optical functional sheet layer.

The term “refractive index . . . substantially the same as” means that for the incident light entering with an angle of 45° (i.e. an angle between the light direction and normal to the sheet plane) from the air to the display device, the reflectance at the interface rounded to unit is zero. Specifically, an average of a reflectance of P-polarization component and a reflectance of S-polarization component of the incident light rounded to unit may be zero.

The third aspect of the invention according to the display device (1) of the first aspect of the invention is characterized in that the layer provided on the observer side of the optical functional sheet layer (12) is a hard coating layer.

The fourth aspect of the invention according to the display device (1) of the first aspect of the invention is characterized in that refractive index of the layer laminated on the observer side of the optical functional sheet layer (12) is substantially the same as that of the light-transmissive portion (13) of the optical functional sheet layer, and the layer provided on the observer side of the optical functional sheet layer is a hard coating layer.

The fifth aspect of the present invention is a display device comprising: an image light source (2); and an optical sheet (30) having a plurality of layers for controlling an incident light from the image light source and for outputting the light to the observer side, wherein the optical sheet comprises an optical functional sheet layer (33) in which light-transmissive portion(s) (34) configured to transmit light and light-absorbing portion(s) (35) configured to absorb light are alternately arranged along the sheet plane, at least two layers (31, 32) are provided on the observer side of the optical functional sheet layer, and refractive indices of these layers laminated on the observer side of the optical functional sheet layer are substantially the same.

The sixth aspect of the invention according to the display device of the fifth aspect of the invention is characterized in that the refractive indices of the layers laminated on the observer side of the optical functional sheet layer (33) are substantially the same as that of the light-transmissive portion (34) of the optical functional sheet layer.

The seventh aspect of the invention according to the display device of the fifth aspect of the invention is characterized in that the layers provided on the observer side of the optical functional sheet layer (33) include at least one hard coating layer.

The eighth aspect of the invention according to the display device of the fifth aspect of the invention is characterized in that the refractive indices of the layers laminated on the observer side of the optical functional sheet layer (33) are substantially the same as that of the light-transmissive portion (34) of the optical functional sheet layer, and the layers provided on the observer side of the optical functional sheet layer include at least one hard coating layer.

According to the present invention, it is possible to provide a display device comprising an optical sheet, which can improve contrast of image light to be provided to the observer.

### BRIEF DESCRIPTION OF THE DRAWINGS

FIG. 1 is a cross-sectional view schematically showing the layer structure of an optical sheet provided to a display device of the first embodiment;

FIG. 2 is an enlarged plan of a part of the optical sheet (including a light-absorbing portion) of FIG. 1;

FIG. 3A is a plan showing another example of the light-absorbing portion (rectangle);

FIG. 3B is a plan showing another example of the light-absorbing portion (trapezoid);

FIG. 3C is a plan showing another example of the light-absorbing portion (inflectional form);

FIG. 3D is a plan showing another example of the light-absorbing portion (curved form);

FIG. 4 is a schematic view showing a layer structure of the optical sheet when provided to a display device and of a PDP part;

FIG. 5A is a plan showing an example of optical path of external light in the display device of FIG. 4;

FIG. 5B is a plan showing an example of optical path of external light in the conventional optical sheet;

FIG. 6 is a schematic view showing a layer structure of the optical sheet and of the PDP part in another example of a display device;

FIG. 7 is a cross-sectional view schematically showing a layer structure of a modified example of the optical sheet;

FIG. 8 is a cross-sectional view schematically showing a layer structure of an optical sheet provided to a display device of the second embodiment;

FIG. 9A is a plan showing an example of optical path of external light in the optical sheet 30; and

FIG. 9B is a plan showing an example of optical path of external light in the conventional optical sheet.

### DESCRIPTION OF THE REFERENCE NUMERALS

1 plasma television (display device)
2 plasma display panel (PDP)
3 glass layer
10, 30 optical sheet
   11, 31 hard coating layer
   12, 33 optical functional sheet layer
   13 light-transmissive portion
14 light-absorbing portion
15 binder portion
16 light-absorbing particle
17 first base material layer

### DESCRIPTION OF THE PREFERRED EMBODIMENTS

The functions and benefits of the present invention will be apparent from the following best modes for carrying out the invention. Hereinafter, the present invention will be described by way of the following embodiments. However, the invention is not limited by the embodiments.

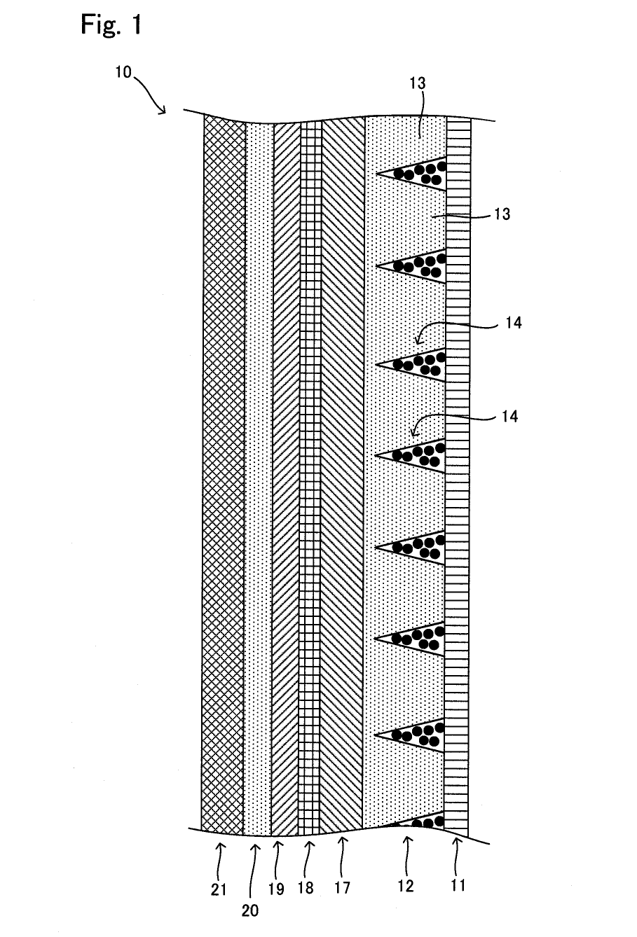

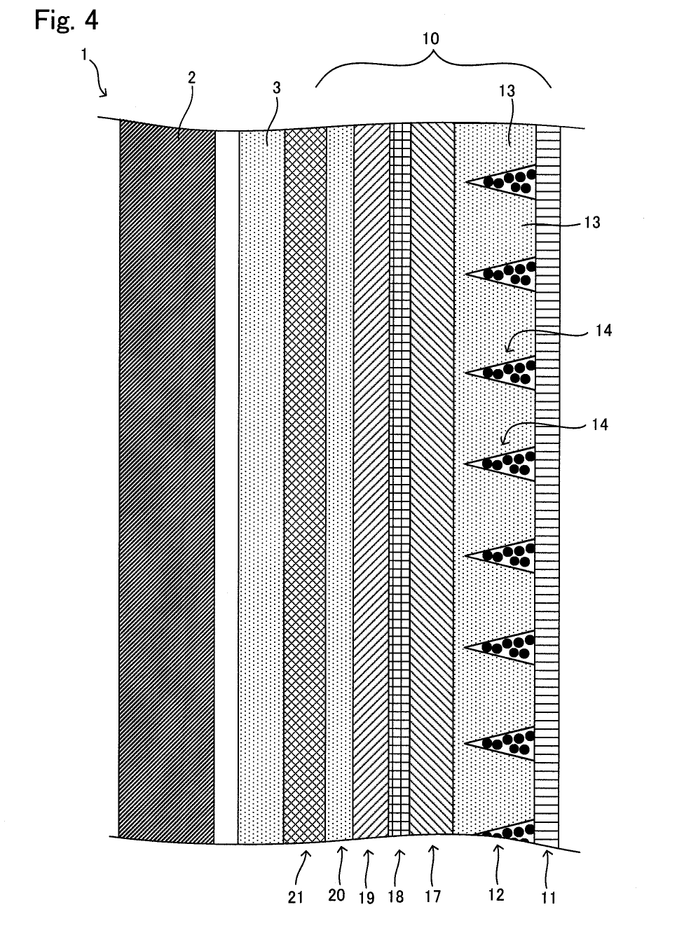

FIG. 1 is a cross-sectional view schematically showing the layer structure of an optical sheet 10 provided to a display device 1 (see FIG. 4.) of the first embodiment. In FIG. 1, for viewability, the repeating reference numerals are partly omitted (the repeating reference numerals are partly omitted in each Figure in the same manner.). The optical sheet 10 is a sheet shape member which transmits an incident light to an observer side and has functions such as filtering light adequately at a time of transmission and controlling the optical path. The optical sheet 10 comprises: a hard coating layer 11, an optical functional sheet layer 12, a first base material layer 17, an adhesive layer 18, an electromagnetic wave shielding layer 19, a second base material layer 20, and a wavelength filter layer 21. In the embodiment, each of the above-described layers is configured to extend in a front-to-back direction of the sheet of FIG. 1 maintaining the cross-section shown in FIG. 1. Each of the layers will be described as follows.

The hard coating layer 11 is a layer consisting of an abrasion-resistant film which is provided to protect the image display from scratching. The thickness of the hard coating layer is not particularly limited; it is preferably 3-15 μm, and more preferably 3-10 μm. If the thickness is less than 3 μm, pencil hardness of the hard coating film is not sufficient; if the thickness is more than 15 μm, the pencil hardness improves but cracks and peeling tend to occur. To afford high pencil hardness to the hard coating film, the pencil hardness of the hard coating layer is desirably 3H to 5H.

Examples of materials for forming the hard coating layer include: ionizing radiation curable resin, thermosetting resin, thermoplastic resin, and engineering plastic. The ionizing radiation curable resin is preferable because it can be easily formed into a plastic substrate film and the pencil hardness can be easily raised up to a desired value.

Examples of the ionizing radiation curable resin preferably include one having an acrylate-based functional groups; it is more preferably a polyester acrylate or an urethane acrylate. The polyester acrylate is preferably constituted by an acrylate or methacrylate (hereinafter, referred to acrylate and/or methacrylate simply as “(meth)acrylate”.) of polyester-based polyol oligomer, or a mixture thereof. The urethane acrylate is constituted by a compound obtained by acrylation of oligomer consisting of a polyol compound and a diisocyanate compound.

Examples of a monomer constituting the acrylate preferably include: methyl (meth)acrylate, ethyl (meth)acrylate, butyl (meth)acrylate, 2-ethylhexyl (meth)acrylate, methoxyethyl (meth)acrylate, butoxy ethyl (meth)acrylate, and phenyl (meth)acrylate.

To raise the hardness, a multifunctional monomer can be used in combination. Preferable examples of the multifunctional monomer include: trimethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, and neopentyl glycol di(meth)acrylate.

Preferable example of the polyester-based polyol oligomer include: polyadipate polyol as condensation products obtained by reacting adipic acid with glycol (e.g. ethylene glycol, polyethylene glycol, propylene glycol, polypropylene glycol, butylene glycol, and polybutylene glycol) or triol (e.g. glycerin, trimethylolpropane); and polysebaciate polyol as condensation products obtained by reacting sebacic acid with glycol or triol.

In addition, a part or all of the aliphatic dicarboxylic acids can be substituted by other organic acids. For example, isophthalic acid, terephthalic acid, and phthalic anhydride can be used as structural component to raise hardness.

The polyurethane-based oligomer can be obtained by condensation of polyisocyanate and polyol. For example, it can be obtained by reacting one selected from the group consisting of: methylene bis(p-phenylene) diisocyanate, hexamethylene diisocyanate-hexanetriol adduct, hexamethylene diisocyanate, tolylene diisocyanate, tolylene diisocyanate-trimethylolpropane adduct, 1,5-naphthylene diisocyanate, thiopropyl diisocyanate, ethylbenzene-2,4-diisocyanate, 2,4-tolylene diisocyanate dimer, hydrogenated xylylene diisocyanate, tris(4-phenylisocyanate) neophosphate, with the following polyol.

Preferable examples of the polyol include: polyether-based polyol such as polyoxy tetramethylene glycol; polyester-based polyol such as polyadipate polyol and polycarbonate polyol; and a copolymer of polyacrylic acid esters and hydroxyethyl methacrylate.

When the ionizing radiation curable resin is used as an ultraviolet curable resin, a photopolymerizer such as α-amyloxim ester and thioxanthones, and photosensitizer such as n-butylamine, triethylamine, and tri-n-butylphosphine can be added thereto.

Urethane acrylate is rich in elasticity and flexibility and is excellent in workability; however, urethane acrylate is poor in surface hardness and it cannot have a pencil hardness of 2H or more. Polyester acrylate can be given a certain hardness by selecting constituents of polyester.

To obtain a flexible hard coating film, it is preferable to add 40-10 parts by mass of polyester acrylate to 60-90 parts by mass of urethane acrylate. By the method, a hard coating film with high hardness and flexibility can be obtained.

So as to adjust gloss and to attain lubricity (but not mold releasability) of the resin, to the coating liquid, 0.3-3 parts by mass of an inorganic particulate having a secondary particle diameter of 20 μm or less, more preferably 0.1-15 μm, is preferably added based on 100 parts by mass of resin component. If the inorganic particulate is 0.3 parts by mass or less, it is difficult to impart intended lubricity; if the inorganic particulate is 3 parts by mass or more, the pencil hardness can be deteriorated.

The above particulates may be: an inorganic particulate such as silica, magnesium carbonate, aluminum hydroxide, and barium sulfate; and an organic polymer particulate such as polycarbonate, acrylic resin, polyimide, polyamide, polyethylene naphthalate, and melamine resin.

Examples of the coating method of the hard coating layer include: roll coating, gravure coating, bar coating, and extrusion coating. A hard coating layer can be formed by a conventional method depending on the properties of the coating composition and coating amount.

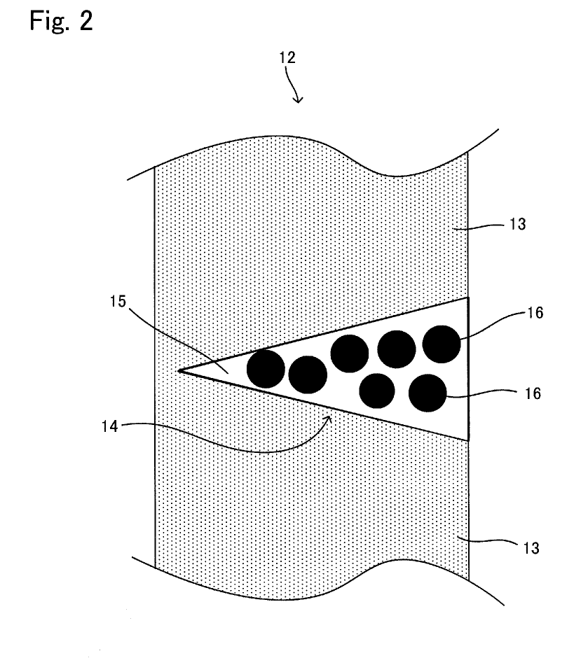

Next, the optical functional sheet layer 12 will be described. As shown in FIG. 1, the optical functional sheet layer 12 comprises: light-transmissive portions 13, 13, of which cross-section view in a direction perpendicular to a normal of the output surface of the optical sheet 10 is substantially trapezoid; and light-absorbing portions 14, 14, each of which is arranged between the light-transmissive portions 13, 13, . . . , In FIG. 2, one of the light-absorbing portions 14 and the neighboring light-transmissive portions 13, 13 of the optical sheet 10 in FIG. 1 are enlarged. The optical functional sheet layer 12 will be described with reference to FIGS. 1 and 2, and other suitable figures.

The light-transmissive portions 13, 13 . . . are arranged so that shorter upper base and longer lower base in the substantially trapezoid cross-sectional view are arranged in a direction along the sheet plane of the optical sheet 10. The shorter upper base in the substantially trapezoid cross-sectional view is the side facing the hard coating layer 11. The light-transmissive portions 13, 13, . . . are made of a light-transmissive resin having a refractive index Nₚ. The value of refractive index is not particularly limited; in view of availability of the material to be applied, 1.40-1.60 is preferable.

The composition for forming the light-transmissive portion is preferably, for example, a light curable resin composition in which a reactive diluent monomer (M1) and a photopolymerization initiator (S1) are added to a light curable prepolymer (P1).

Examples of the light curable prepolymer (P1) include: prepolymer such as epoxy acrylate-based, urethane acrylate-based, polyether acrylate-based, polyester acrylate-based, and polythiol-based prepolymer.

Examples of the reactive diluent monomer (M1) include: vinylpyrrolidone, 2-ethylhexyl acrylate, g-hydroxy acrylate, and tetrahydrofurfuryl acrylate.

Examples of the photopolymerization initiator (S1) include: hydroxybenzoyl compounds such as 2-hydroxy-2-methyl-1-phenylpropane-1-one, 1-hydroxycyclohexyl phenyl ketone, benzoin alkyl ether; benzoyl formate compounds such as methyl benzoyl formate; thioxanthone compounds such as isopropyl thioxanthone; benzophenones such as benzophenone; acylphosphine oxide compounds such as 2,4,6-trimethylbenzoyl diphenylphosphine oxide, bis(2,4,6-trimethylbenzoyl)phenylphosphine oxide; and benzyl dimethyl ketal. Among them, photopolymerization initiator can be arbitrarily selected depending on the irradiation apparatus for curing light curable resin composition and curing property of the light curable resin composition. The preferable ones in view of color protection of the light-transmissive portions 13, 13, . . . are 2-hydroxy-2-methyl-1-phenylpropane-1-one, 1-hydroxycyclohexyl phenyl ketone, and bis(2,4,6-trimethyl benzoyl) phenylphosphine oxide.

The amount of photopolymerization initiator (S1) contained in the light curable resin composition, in view of curing property and cost of the light curable resin composition, is preferably 0.5-5.0 mass % based on a total amount of the composition which forms the light-transmissive portion as 100 mass %. In general, photopolymerization initiator is at least partly soluble (for example, at a processing temperature of the resin) and it is substantially colorless after polymerization. The photopolymerization initiator may be colored (for example, in yellow) on the condition that it becomes substantially colorless when the composition for forming the light-transmissive portion is cured to form the light-transmissive portion.

The light curable prepolymer (P1), reactive diluent monomer (M1), and photopolymerization initiator (S1) to be used may respectively be single species or a combination of two or more species thereof.

As required, for property modification as well as improvement of coating properties and of mold releadability from the die rolls when using die rolls in the production process, various additives such as silicone-based additive, rheology control agent, antifoaming agent, mold release agent, antistatic agent, and ultraviolet absorber can be added to the composition for forming the light-transmissive portion.

The light-absorbing portions 14, 14, . . . are arranged between the light-transmissive portions 13, 13, . . . and are elements having substantially triangle cross-sectional view shown in FIG. 1. The substantially triangle cross-sections are aligned so that the face equivalent to the bottom of the substantially triangle cross-section extends on the upper base of the light-transmissive portions 13, 13, . . . . In other words, one face of the optical functional sheet layer 12 is formed by the bottom of the light-absorbing portions 14, 14, . . . and the upper base of the light-transmissive portions 13, 13, . . . . Here, the oblique lines of the substantially triangle cross-section of the light-absorbing portions 14, 14, . . . preferably make an angle of 0-10° against normal to the plane of the optical sheet 10.

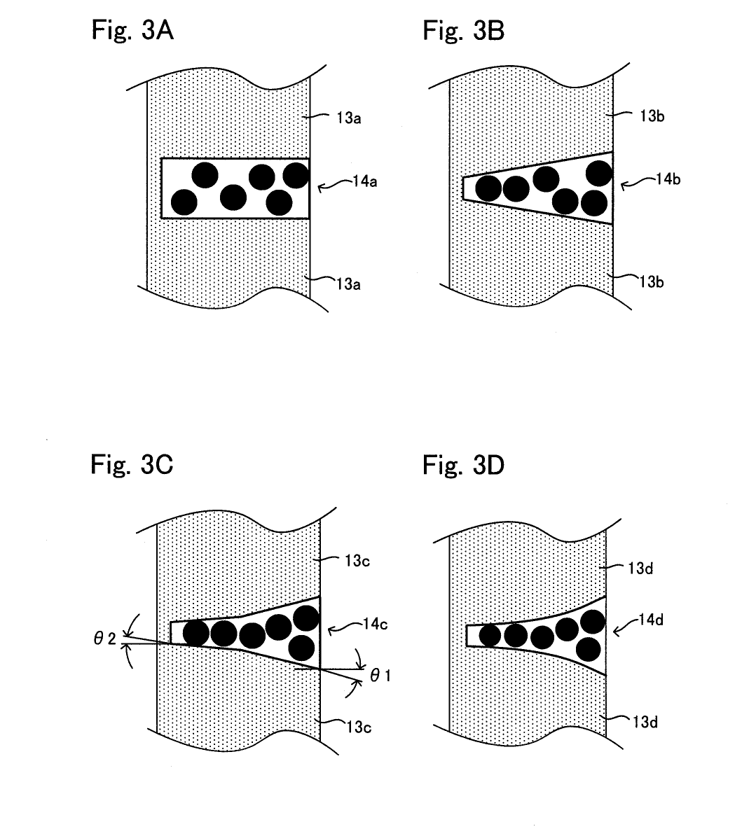

In this embodiment, cross section of the light-transmissive portions 13, 13, . . . are substantially trapezoid and cross section of the light-absorbing portions 14, 14, . . . are substantially triangle; however, these are not limited to the shapes. The following cross-sectional shapes may be the examples (see FIGS. 3A to 3D.).

FIG. 3A is an example in which the light-transmissive portion 13a and the light-absorbing portion 14a respectively have rectangle cross-sectional view. In other words, it is an example where oblique lines of the above described light-transmissive portion and oblique lines of the light-absorbing portion make an angle of 0° against normal to the plane of the optical sheet 10.

FIG. 3B is an example in which the cross section of the light-absorbing portion 14b is trapezoid. So, in this example, the shorter upper base of the light-absorbing portion 14b is aligned on the side of the longer lower base of the light-transmissive portion 13b.

The slope of the oblique line is not necessarily constant; and the oblique line may be a polygonal line or a curved line. FIG. 3C is an example that the oblique lines in the cross section of the light-absorbing portion 14c are polygonal lines. In the example, an oblique line of the light-absorbing portion 14c (it is also an oblique line of the light-transmissive portions 13c, 13c.) does not consist of one line but consist of two lines. In other words, in the cross section, the oblique line is polygonal. More specifically, the lower-base-side oblique line (right side in FIG. 3C) makes an angle of θ1 with a normal to the output plane of the optical sheet 10. On the other hand, the other side of the oblique line (left side in FIG. 3C) makes an angle of θ2 with a normal to the output plane of the optical sheet 10. There is a relation: θ1>θ2. Both θ1 and θ2 are preferably within the range of more than 0° and 10° or less, and more preferable angles are within the range of more than 0° and 6° or less.

Although each side of the oblique line of the light-absorbing portion 14c in the example of FIG. 3C consists of two oblique lines, the oblique line may be formed by polygonal line having more than two lines.

FIG. 3D is an example that each side of the oblique line in the cross-section of the light-absorbing portion 14d (these are also oblique lines of the light-transmissive portion 13d.) is formed of a curved line. In this way, the oblique line of the substantially triangle cross section of the light-absorbing portion may be a curved line. In this case, the angle between the curved line and the normal to the output plane of the sheet of the optical sheet at the upper-base-side (left side in FIG. 3D) is preferably smaller than that at the lower-base-side. In addition, every angle on the curved line is preferably within the range of 0° or more and 10° or less, and more preferably within the range of more than 0° and 6° or less. The angle between the curved line and the normal to the output plane of the sheet is defined by an angle between the normal to the output plane of the sheet and lines made by dividing a curved line into ten equal parts and connecting two adjacent ends of the segments.

The light-absorbing portions 14, 14, . . . are formed of a certain material of which refractive index is the same as the refractive index Nₚ of the light-transmissive portions 13, 13, or is refractive index N_{b} smaller than refractive index Nₚ. By setting the relation between the refractive index Nₚ of the light-transmissive portions 13, 13 . . . and the refractive index N_{b} of the light-absorbing portions 14, 14, . . . as Nₚ≧N_{b}, it is possible to adequately reflect an image light from the light source which has entered into the light-transmissive portions 13, 13, . . . under certain conditions at an interface between light-absorbing portions 14, 14, . . . and the light-transmissive portions 13, 13, . . . and possible to provide a bright image to the observer. The difference between the refractive indices Nₚ and N_{b} are not particularly limited; it is preferably 0 or more and 0.06 or less.

Although the relation: Nₚ≧N_{b} is preferable in this embodiment, the relation between Nₚ and N_{b} is not limited to it. It is possible to form the light-absorbing portions 14, 14, . . . so that refractive index of the light-transmissive portion is smaller than that of the light-absorbing portion.

The light-absorbing portions 14, 14, . . . of this embodiment comprises: light-absorbing particles 16, 16, . . . ; and a binder portion 15 to be filled between the outer periphery and the light-absorbing particles 16, 16, . . . . In other words, the light-absorbing particles 16, 16, . . . are dispersed in the binder portion 15. By this configuration, the image light entering into the light-absorbing portions 14, 14, . . . can be absorbed at the light-absorbing particles 16, 16, . . . without being reflected at an interface between the light-transmissive portions 13, 13, . . . and the light-absorbing portions 14, 14, . . . . Moreover, an external light entering at a certain angle from the observer side can be adequately absorbed; thereby the contrast can be improved. In this case, binder material for forming the binder portion 15 is the above material having refractive index N_{b}.

The light-absorbing portion is formed by, for example, dispersing light-absorbing particles in a light curable resin as the binder material. The material to be used as the binder is not particularly limited; for instance, a light curable resin composition in which reactive diluent monomer (M2) and a photopolymerization initiator (S2) are mixed with a light curable prepolymer (P2) is preferably used.

Examples of light curable prepolymer (P2) include: urethane (meth)acrylate, polyester (meth)acrylate, epoxy (meth)acrylate, and butadiene (meth)acrylate.

Examples of the reactive diluent monomer (M2) as monofunctional monomer include: vinyl monomers such as N-vinylpyrrolidone, N-vinylcaprolactone, vinylimidazole, vinylpyridine, and stylene; monomers of (meth) acrylic acid ester and (meth)acrylamide derivatives such as lauryl (meth)acrylate, stearyl (meth)acrylate, butoxyethyl (meth)acrylate, ethoxy diethylene glycol (meth)acrylate, methoxy triethylene glycol (meth)acrylate, methoxy polyethylene glycol (meth)acrylate, methoxy dipropylene glycol (meth)acrylate, para-cumyl phenoxyethyl (meth)acrylate, nonylphenoxy polyethylene glycol (meth)acrylate, tetrahydrofurfuryl (meth)acrylate, isobornyl (meth)acrylate, cyclohexyl (meth)acrylate, benzyl methacrylate, N,N-dimethyl(meth)acrylamide, N,N-dimethylaminopropyl (meth)acrylate, and acryloylmorpholine. Examples of the reactive diluent monomer (M2) as multifunctional monomer include: ethylene glycol di(meth)acrylate, diethylene glycol di(meth)acrylate, triethylene glycol di(meth)acrylate, polyethylene glycol di(meth)acrylate, tripropylene glycol di(meth)acrylate, polytetramethylene glycol di(meth)acrylate, 1,4-butanediol di(meth)acrylate, 1,6-hexanediol di(meth)acrylate, 1,9-nonanediol di(meth)acrylate, 3-methyl-1,5-pentanediol di(meth)acrylate, neopentyl glycol di(meth)acrylate, dimethyloltricyclodecane di(meth)acrylate, hydroxy pivalic acid neopentyl glycol di(meth)acrylate, bisphenol A polypropoxydiol di(meth)acrylate, trimethylolpropane tri(meth)acrylate, ethoxylated trimethylolpropane tri(meth)acrylate, propoxylated trimethylolpropane tri(meth)acrylate, pentaerythritol tri(meth)acrylate, glyceryl tri(meth)acrylate, propoxylated glyceryl tri(meth)acrylate, tris(2-hydroxyethyl) isocyanurate triacrylate, pentaerythritol tetra(meth)acrylate, ditrimethylolpropane tetra(meth)acrylate, dipentaerythritol penta(meth)acrylate, and dipentaerythritol hexa(meth)acrylate.

Examples of the photopolymerization initiator (S2) include: 1-hydroxycyclohexyl phenyl ketone, 2-hydroxy-2-methyl-1-phenylpropane-1-one, 2,2-dimethoxy-1,2-diphenylethane-1-one, 2,4,6-trimethylbenzoyldiphenylphosphine oxide, and bis (2,4,6-trimethylbenzoyl) phenylphosphine oxide. Among them, the photopolymerization initiator (S2) can be arbitrarily selected depending on the irradiation apparatus for curing light curable resin composition and curing property of the light curable resin composition.

In view of curing property and cost of the light curable resin composition, the amount of photopolymerization initiator (S2) contained in the light curable resin composition based on a total amount of the light curable resin composition (100 mass %) is preferably 0.5-10.0 mass %.

The light curable prepolymer (P2), reactive diluent monomer (M2), and photopolymerization initiator (S2) to be used may respectively be single species or a combination of two or more species thereof.

More specifically, these are arbitrarily mixed in view of refractive index, viscosity, effect on the property of the optical functional sheet layer 12, and so on of the photopolymerizable component (specifically, the light curable prepolymer (P2) and the reactive diluent monomer (M2)) consisting of urethane acrylate, epoxy acrylate, tripropylene glycol diacrylate, and methoxy triethylene glycol acrylate.

Moreover, as required, additives such as silicone, antifoaming agent, leveling agent, and solvent may be added to the composition constituting the light-absorbing portion.

As the light-absorbing particle, light-absorbing colored particles such as carbon black are preferably used. However, the light-absorbing particle is not limited to it; colored particles which can selectively absorb a light having a certain wavelength can be used depending on the properties of the image light. More specifically, for example, colored glass beads or organic particulates colored by carbon black, graphite, metal salt such as black iron oxide, dye, and pigment, may be used. Particularly, in view of cost, quality, and availability, the colored organic particulates are preferably used. More specifically, for example, acrylic cross-linked particulate containing carbon black and urethane cross-linked particulate containing carbon black are preferably used. Such colored particles are usually contained in the composition constituting the light-absorbing portion within the range of 3-30 mass %. The average diameter of the colored particles is preferably 1.0 μm or more and 20 μm or less. As described below, when the light-absorbing portions 14, 14, . . . are formed, a step for strickling the excessive amount of the composition constituting the light-absorbing portion by using doctor blade is included after filling the composition constituting the light-absorbing portion containing the colored particles in a recess between the light-transmissive portions 13, 13, . . . . During this step, by using colored particles having an average diameter of 1.0 μm or more, the colored particles hardly slip through the gap between the doctor blade and the upper side of the light-transmissive portions 13, 13, . . . , so it is possible to prevent the colored particles from remaining on the upper plane of the light-transmissive portions 13, 13, . . . .

The light absorbing means is not limited to the method by using the light-absorbing particles of this embodiment. For example, coloring the entire light-absorbing portion by pigment or dye may be possible.

Next, the first base material layer 17 will be described. The first base material layer 17 is laminated on one face, opposite to the hard coating layer 11, of the optical functional sheet layer 12. The first base material layer 17 is a film layer which is a base material layer for forming the optical functional sheet layer 12 thereon.

The first base material layer 17 is preferably constituted by a material containing polyethylene terephthalate (PET) as the main component. When the first base material layer 17 contains PET as the main component, the first base material layer 17 may contain other resins. In addition, various additives may be adequately added thereto. Examples of conventional additives include: antioxidant such as phenol-based compounds and stabilizer such as lactone-based compounds. The term “main component” means that 50 mass % or more of PET is contained based on the whole material for forming the base material (hereinafter, it means the same.).

The main component of the material constituting the first base material layer 17 is not necessarily PET; other materials can be used. Examples of other materials include: polyester-based resin such as polybutylene terephthalate, polyethylene naphthalate, and terephthalic acid-isophthalic acid-ethylene glycol copolymer, terephthalic acid-cyclohexanedimethanol-ethylene glycol copolymer; polyamide-based resin such as nylon 6; polyolefin-based resin such as polypropylene and polymethylpentene; acrylic resin such as polymethyl methacrylate; stylene-based resin such as polystylene and stylene-acrylonitrile copolymer; cellulose-based resin such as triacetylcellulose; imide-based resin; and polycarbonate resin. To these resins, as required, additives such as ultraviolet absorber, filler, plasticizer, and antistatic agent may be adequately added.

In this embodiment, in view of mass production, cost, and availability as well as its performance, a base material layer 17 is made of a resin mainly containing PET as a preferable mode of the invention.

The adhesive layer 18 is an acrylic adhesive layer and is arranged on one face, opposite to the optical functional sheet layer 12, of the first base material layer 17. In this embodiment, acrylic adhesive is used as an adhesive; however, the kind of adhesive is not limited to the acrylic adhesive as long as the adhesive can have required performances such as optical transparency, adhesiveness, and weatherability. The adhesive force is preferably, for example, from several to 20 N/25 mm. When the adhesive is applied on a glass surface, in view of rework in the production process and recycling, from several to 10 N/25 mm is more preferable.

As seen in this embodiment, when the adhesive layer is adhered to contact electromagnetic wave shielding layer, antioxidant (e.g. benzotriazole) is preferably contained or acid group (e.g —COOH) is not preferably contained.

The electromagnetic wave shielding layer 19 is laminated on the adhesive layer 18 and literally has a function to shield electromagnetic wave. As long as the layer has this function, the means for shielding electromagnetic wave is not particularly limited. Examples thereof may be a copper mesh. In this embodiment, a mesh pattern formed by printing is shown. That is, a primer layer is provided on the below-described second base material layer 20 and then a conductive composition is transferred on the primer layer, to produce an electromagnetic wave shielding layer 19. Pitches and so on of the copper mesh can be adequately designed depending on the electromagnetic wave to be shielded; a mesh having a pitch of about 300 μm and a line width of 12 μm may be exemplified. Other methods to obtain the copper mesh may be to produce a fine copper mesh pattern by e.g. etching or vapor deposition.

The second base material layer 20 is a base layer of the electromagnetic wave shielding layer 19. The second base material layer 20 can be made of the common material to that of the first base material layer 17.

The wavelength filter layer 21 is also laminated in the side, opposite to the side of antireflection layer 11, of the optical functional sheet layer 12. The wavelength filter layer 21 has a function of filtering a light of certain wavelength. As required, the wavelength to be filtered can be adequately selected; the wavelength filter layer can have functions of absorbing neon line emitted from the PDP, cutting infrared rays and near-infrared ray, and adjusting color tone. The wavelength filter layer often contains dye, so, in such a case, ultraviolet absorber is preferably contained. By adding ultraviolet absorber, deterioration of color can be inhibited. The wavelength filter layer 21 has at least one of the above functions. When the wavelength filter layer has a plurality of functions, the layer may be a single layer having the plurality of functions or may consist of laminated layers each having a particular function. Moreover, the wavelength filter layer 21 may contain adhesive to help lamination of other layers. The respective functions are shown as below.

As a near-infrared ray absorbing filter, a commercially available film (for example, commodity name “No. 2832” manufactured by Toyobo Co., Ltd.) having near-infrared ray absorbent can be used. In addition, a layer obtained by film-forming using a composition containing resin or the like in which near-infrared ray absorbing dye is dispersed can be used; or a layer obtained by coating the composition on a transparent base material or on other functional filter, then, as required, drying and curing can be used.

The near-infrared ray absorbing dye to be used is the one absorbing a near-infrared ray in a wavelength region attributed to xenon discharge emitted from the PDP, in other words, the one absorbing a near-infrared ray in a wavelength range of 800-1100 nm. The transmissivity of the near-infrared ray in the wavelength range is preferably 20% or less, and more preferably 10% or less. Moreover, the near-infrared ray absorbing filter desirably has a sufficient light transmissivity in a visible light region, namely, in a wavelength range of 380-780 nm.

Specific examples of near-infrared ray absorbing dye include: organic near-infrared ray absorbing dye such as polymethine-based compound, cyanine-based compound, phthalocyanine-based compound, naphthalocyanine-based compound, naphthoquinone-based compound, anthraquinone-based compound, dithiol-based compound, immonium-based compound, diimmonium-based compound, aminium-based compound, pyrylium-based compound, cerylium-based compound, squarylium-based compound, copper complexes, nickel complexes, and dithiol-based metal complexes; inorganic near-infrared ray absorbing dye such as tungsten oxide, tin oxide, indium oxide, magnesium oxide, titanium oxide, chromium oxide, zirconium oxide, nickel oxide, aluminum oxide, zinc oxide, iron oxide, antimony oxide, lead oxide, bismuth oxide, and lanthanum oxide. These may be used alone or in combination of two or more thereof.

Examples of the resin in which the near-infrared ray absorbing dye is dispersed include: polyester resin, polyurethane resin, acrylic resin, and epoxy resin. The drying and curing methods of the resin may be: a drying-solidifying method by evaporating solvent (or dispersion media) from the solution (or emulsion); a curing method employing polymerization and/or cross-linking reaction by energy such as heat, ultraviolet rays, and electron beam; or another curing method employing polymerization and/or cross-linking reaction of functional group in the resin (e.g. hydroxyl group and epoxy group) with, for example, an isocyanate group in the curing agent.

The neon line absorbing filter is used for absorbing neon light (namely, emission spectrum of neon atom) radiated from the PDP. The emission spectal range of neon light is in a wavelength range of 550-640 nm, so the neon line absorbing filter is preferably designed so that the spectral transmissivity is 50% or less in the wavelength of 550-640 nm. The neon absorbing filter may be: a membrane made of a composition containing a resin and the like in which a conventionally used dye (neon line absorbing dye) having an absorption maximum in a wavelength range of at least 550-640 nm is dispersed; or a film obtained by applying the composition on a transparent base material or other functional filter and then, as required, by drying and curing the applied composition. Specific examples of the neon line absorbing dye include: cyanine-based, oxonol-based, methine-based, subphthalocyanine-based, and porphyrin-based compounds. Moreover, the resin used for dispersing the neon line absorbing dye can be the similar one to the resin for dispersing the near-infrared ray absorbing dye.

The filter for adjusting color tone is to adjust color of the optical sheet so as to improve purity and color reproduction range of the light emitted from the PDP as well as to improve color of display in the off state. Examples of the color-tone adjusting filter may be: a membrane made of a composition in which a color-tone adjusting dye is dispersed in a resin; or a film obtained by applying the composition on a transparent base material or other functional filter and then, as required, by drying and curing the applied composition. As the color-tone adjusting dye, among known dyes each having wavelength of maximum absorption in a visible light range of 380-780 nm, the dyes can be used in arbitrary combination depending on the intended purpose. Examples of the known dye usable as the color-tone adjusting dye include: dyes disclosed in Japanese Patent Application Laid-Open (JP-A) No. 2000-275432, JP-A No. 2001-188121, JP-A No. 2001-350013, and JP-A No. 2002-131530. In addition, dyes (which absorb visible light such as yellow light, red light and blue light) such as anthraquinone-based, naphthalene-based, azo-based, phthalocyanine-based, pyrromethene-based, tetraazaporphyrin-based, squarylium-based, cyanine-based dyes can be used as the color-tone adjusting dye. The resin for dispersing the color-tone adjusting dye may be the one similar to the resin for dispersing the near-infrared ray absorbing dye.

The wavelength filter layer has been described as one layer; however, the wavelength filter layer may be a combination of two or more layers each of which has a certain function. The wavelength filter layer may be configured to be included in an adhesive, or the wavelength filter layer may have an adhesive function. Hence, it is possible to apply a function of wavelength filtering to the above-described adhesive layer 18.

When a ultraviolet curable resin is used for, for example, the hard coating layer and the optical functional sheet layer, due to the influence of the initiator contained in the layer on the wavelength filter layer, color tends to be deteriorated. So, it is preferable to form a layer structure so that the layer using the ultraviolet curable resin and the wavelength filter layer are not directly in contact with each other.

As seen above, in the optical sheet 10, on one side of the optical functional sheet layer 12, only the hard coating layer 11 is arranged and no other layer is arranged; thereby, it is possible to provide a high contrast image to the observer. The detail will be described later.

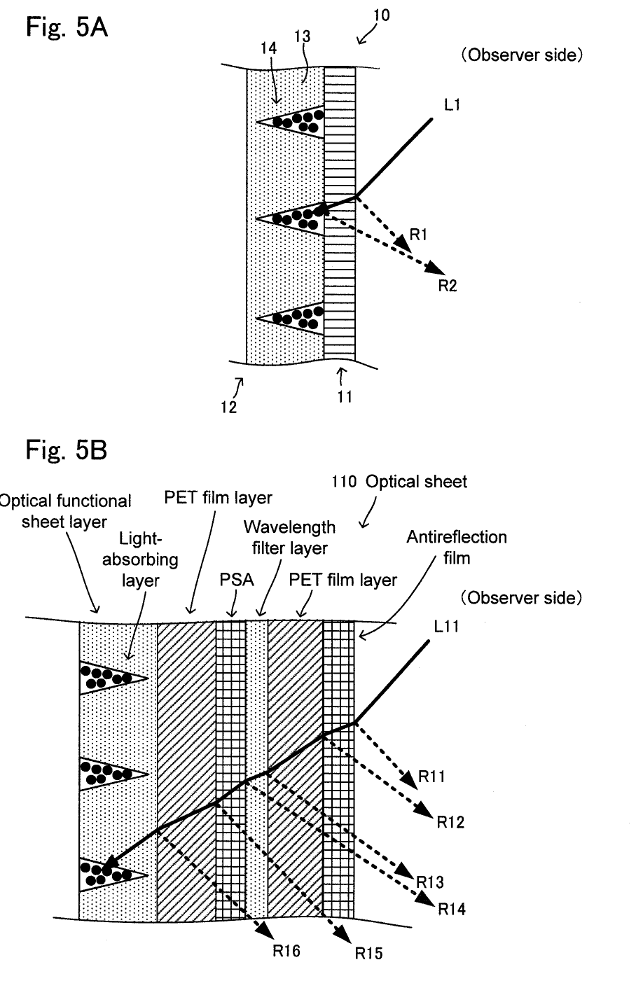

Next, the display device 1 of the first embodiment will be described. The effect to attain high contrast will also be described. FIG. 4 is a cross-sectional view focusing on the parts where a PDP 2 and an optical sheet 10 are arranged, in the case where the optical sheet 10 is arranged on the image-light-outgoing-side of the PDP 2 and the plasma television 1 as a display device is provided with the PDP 2 and the optical sheet 10. In FIG. 4, right side of the paper is the observer side. FIG. 5A and FIG. 5B are schematic views enlarging a part of FIG. 4 and illustrating the optical path.

As shown in FIG. 4, in the display device 1, the optical sheet 10 is adhered on the observer side surface of a glass layer 3 which is provided on the image-light-outgoing-side across a certain space from the PDP 2 as an image light source. In this circumstance, the wavelength filter layer 21 is configured to face the glass layer 3. Therefore, the hard coating layer 11 of the optical sheet 10 is arranged at the nearest side of the observer. The PDP 2 to be used may be a conventional one.

The display device 1 is the so-called “glass filter system” plasma television, in which the optical sheet 10 is adhered on the glass layer 3, as above. The glass layer 3 is a layer formed of a glass plate. Here, although the glass layer 3 is described separately from the optical sheet 10, a combination of the glass layer 3 and the optical sheet 10 are sometimes called optical sheet.

The display device 1 will be described based on the optical path of the external light. FIG. 5A is an example of the optical sheet 10; FIG. 5B is an example of conventional optical sheet 110. External lights L1 and L11 are the light respectively enter into the optical sheets 10 and 110 from the observer side. Examples of the external light may be sunlight and electric light in the room.

In the conventional optical sheet 110 in FIG. 5B, when the external light L11 enters into the optical sheet 110, the external light L11 passes through many interfaces of the laminated films before it reaches and is absorbed by the light absorbing layer; thereby reflected lights R11-R16 are produced at the respective interfaces and emitted to the observer side. Thus, it cannot be said that the light-absorbing portion sufficiently functions, which results in deterioration of the contrast.

On the other hand, in the optical sheet 10 shown in FIG. 5A, when the external light L1 enters into the optical sheet 10, only the hard coating layer 11 is arranged on the observer side of the optical functional sheet layer 12. So, it is possible to inhibit the chance of reflection (only R1 and R2 can be caused.). Therefore, the optical sheet 10 is capable of sufficiently exhibiting the function of the light-absorbing portion 14 and of improving the contrast of the image compared with that of the conventional optical sheet.

Meanwhile, even when a plurality of layers are provided between the hard coating layer 11 and the optical functional sheet layer 12, if the refractive index of the sandwiched layers are the same, reflection can be inhibited in these layers; therefore, the same effect as the case of adhering only the hard coating layer 11 is adhered can be obtained. In other words, even when additional hard coating layer(s) and/or other functional layer(s) are provided between the hard coating layer 11 and the optical functional sheet layer 12, it is permissible as long as these layers have substantially the same refractive index as that of the hard coating layer 11.

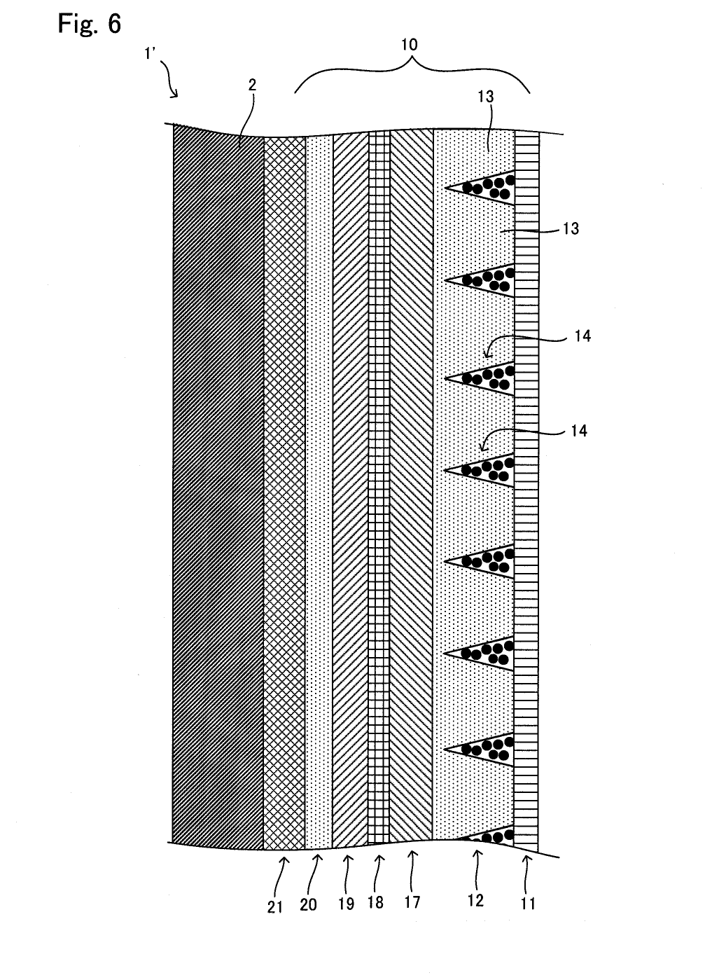

FIG. 6 schematically illustrates a display device 1′ which is an example different from the display device 1 of FIG. 4. FIG. 6 corresponds to FIG. 4. The display device 1′ is a type in which the optical sheet 10 is directly adhered to the PDP 2 without using any glass layer. According to the mode, no glass layer and no space are necessary; thereby it is possible to provide a thinner-profile plasma television.

By the display device 1′, due to the same reasons as described above, it is possible to improve the contrast.

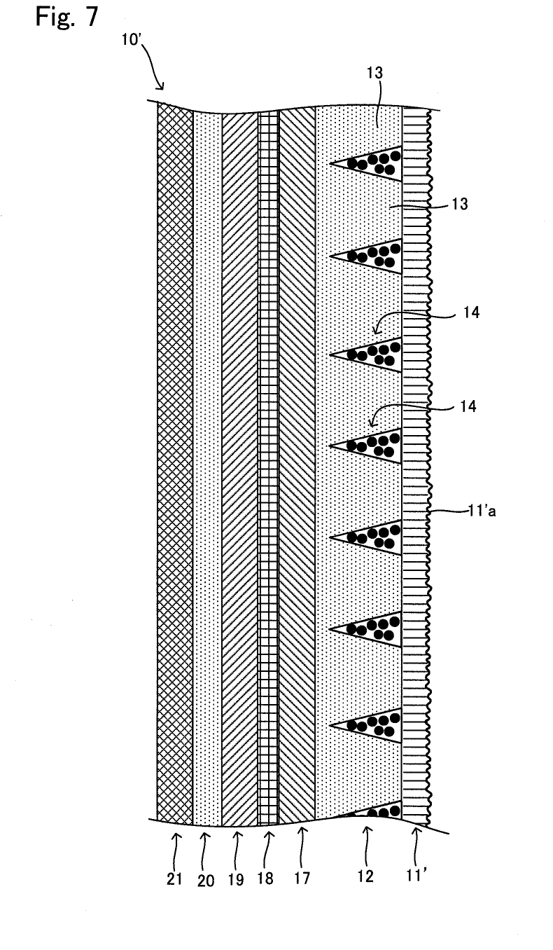

FIG. 7 illustrates an optical sheet 10′ provided to the modified example of display device 1 and schematically shows the layer structure. The optical sheet 10′ is an example in which a hard coating layer 11′ having a mat face 11′ a in its observer side is laminated instead of laminating the hard coating layer 11 of the optical sheet 10. By using the optical sheet 10′, it is possible to inhibit glare at the surface of the optical sheet 10′. The hard coating layer 11′ can be formed by giving surface pattern using dies.

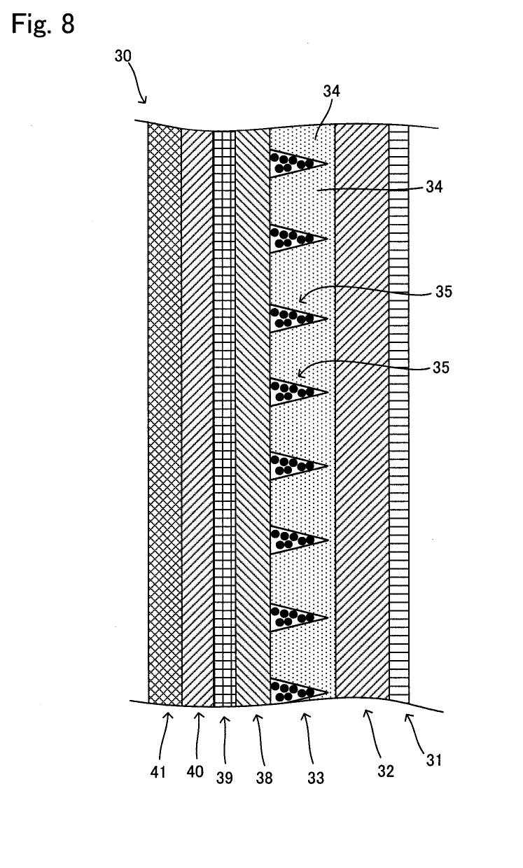

FIG. 8 is a cross-sectional view of the optical sheet 30 provided to a display device according to the second embodiment and schematically shows the layer structure. In view of viewability, the repeating reference numerals are partly omitted. The optical sheet 30 comprises: a hard coat layer 31, a first base material layer 32, an optical functional sheet layer 33, an adhesive layer 38, an electromagnetic wave shielding layer 39, a second base material layer 40, and a wavelength filter layer 41. These layers of the optical sheet 30 are laminated in the mentioned order. In this embodiment, each layer is configured to extend in a front-to-back direction of the sheet of FIG. 8 while maintaining the cross-section shown in FIG. 8. Each of the layer will be described as follows.

The optical sheet 30 is different from the optical sheet 10 in the points that: the first base material layer 32 equivalent to the base material layer 17 of the optical sheet 10 is arranged between the optical functional sheet layer 33 and the hard coating layer 31; the optical functional sheet layer 33 is the reverse of the optical functional sheet layer 12 in terms of the light-absorbing portion; and a second base material layer 40 is provided between the optical functional sheet layer 33 and an adhesive layer 39. Hereinafter, the optical sheet 30 will be described in detail.

The hard coating layer 31, in the same manner as the hard coating layer 11, is a layer consisting of a film which has functions including abrasion-resistance to protect the image display from scratching. The hard coating layer 31 can be made of the common material to that of the hard coating layer 11, so the description is omitted. The hard coating layer 31 of the optical sheet 30 has substantially the same refractive index as that of the first base material layer 32.

The first base material layer 32 is provided on the optical functional sheet layer 33 side of the hard coating layer 31. The first base material layer 32 is a film layer as a base material layer for forming the optical functional sheet layer 33 thereon. The material is common to that of the base material layer 17, so the description is omitted.

It should be noted that the first base material layer 32 has substantially the same refractive index as that of the hard coating layer 31. Because of this, the contrast can be improved compared with the conventional one. It will be described in detail as follows.

The optical functional sheet layer 33 comprises: light-transmissive portions 34 and light-absorbing portions 35. These are common with those of the optical functional sheet layer 12, so the description is omitted. It should be noted that, in the optical functional sheet layer 33, the longer lower base of the substantially trapezoid in cross-section of the light-transmissive portion 34 faces the first base material layer 32. Thus, the shorter upper base of the light-transmissive portion 34 faces the second base material layer 40.

The adhesive layer 38 and the electromagnetic wave shielding layer 39 are respectively common with the above-described adhesive layer 18 and the electromagnetic wave shielding layer 19, so the description is omitted.

The second base material layer 40 is a layer to be the base of the electromagnetic wave shielding layer 39. The second base material layer 40 is common with the second base material layer 20, so the description is omitted.

The wavelength filter layer 41 is also common with the above-described wavelength filter layer 20, so the description is omitted.

In this way, in the optical sheet 30, only the first base material layer 32 is arranged between the optical functional sheet layer 33 and the hard coating layer 31 as the outermost layer, and the refractive indices of the hard coating layer 31 and that of the first base material layer 32 are substantially the same. The optical sheet 30, in the same manner as the optical sheet 10, is directly laminated on a glass layer or a PDP. Accordingly, it is possible to provide an image with high contrast to the observer. Hereinafter, the optical sheet 30 will be described in detail.

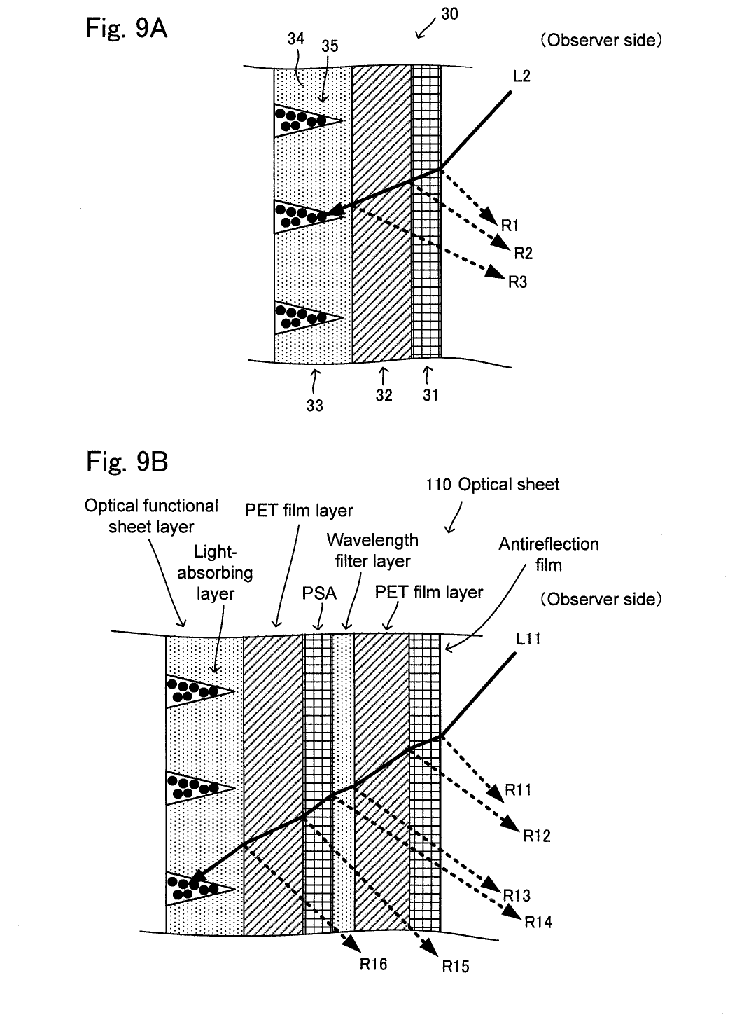

FIG. 9A corresponds to FIG. 5A and schematically illustrates an example of the optical path of the external light entering into the optical sheet 30. FIG. 9A shows an example of the optical sheet 30; FIG. 9B shows an example of conventional optical sheet 110. The external lights L2 and L11 are the light respectively enter into the optical sheets 30 and 110 from the observer side. Examples of the external lights may be sunlight and electric light in the room.

In the conventional optical sheet 110 in FIG. 9B, when the external light L11 enters into the optical sheet 110, the external light L11 passes through many interfaces of the laminated films before it reaches and is absorbed by the light absorbing layer; thereby reflected lights R11-R16 are produced at the respective interfaces and emitted to the observer side. Thus, it cannot be said that the light-absorbing portion sufficiently functions, which results in deterioration of the contrast.

On the other hand, in the optical sheet 30 shown in FIG. 9A, since the first base material layer 32 and the hard coating layer 31 have substantially the same refractive index, when the external light L2 enters into the optical sheet 30, among reflections R1 to R3 produced in the interfaces, it is possible to significantly reduce the reflection of R2 or to hardly cause the reflection R2. Therefore, the optical sheet 30 is capable of sufficiently exhibiting the function of the light-absorbing portion 35 and capable of improving the contrast of the image compared with that of the conventional optical sheet.

In addition, if the refractive index of the first base material layer 32 and the refractive index of the light-transmissive portion 34 are substantially the same, it is possible to reduce the reflection of R3 in FIG. 9A even further or possible to completely inhibit the reflection and thus it is possible to further improve the contrast. In a case when the refractive index of the first base material layer 32 and the refractive index of the light-transmissive portion 34 are similar to each other, it is possible to inhibit reflection of R3 and possible to improve the contrast.

As above, a specific layer structure has been described in each embodiment. However, kinds and laminating order of the layer(s) arranged between the optical functional sheet layer and the image light source are not particularly limited; it is adequately changed.

### EXAMPLES

Hereinafter, the invention will be more specifically described by way of the following examples. However, the present invention is not limited by the examples.

In the examples, optical sheets having the layer structure shown in Table 1 were produced and assembled into display devices. Then, the contrast was evaluated.

TABLE 1

| No. | Layer structure (from the left to the Observer side) | Evaluation | |
|---|---|---|---|
| 1 | Hard coating layer/Optical functional sheet layer/1st base material | ◯ | Example |
| | layer/Adhesive layer/Electromagnetic wave shielding layer/2nd | | |
| | base material layer/Wavelength filter layer | | |
| 2 | Hard coating layer/Hard coating layer/Optical functional sheet | ◯ | Example |
| | layer/1st base material layer/Adhesive layer/Electromagnetic wave | | |
| | shielding layer/2nd base material layer/Wavelength filter layer | | |
| 3 | Hard coating layer/1st base material layer/Optical functional sheet | ◯ | Example |
| | layer/Adhesive layer/Electromagnetic wave shielding layer/2nd | | |
| | base material layer/Wavelength filter layer | | |
| 4 | Hard coating layer/Base material layer/Glass layer/Base material | X | Comparative |
| | layer/Electromagnetic wave shielding layer/Adhesive layer/Base | | example |
| | material layer/Optical functional sheet layer/Adhesive layer/Base | | |
| | material layer/Wavelength filter layer | | |
| 5 | Hard coating layer/Base material layer/Wavelength filter | Δ | Comparative |
| | layer/Adhesive layer/Optical functional sheet layer/Base material | | example |
| | layer/Adhesive layer/Electromagnetic wave shielding layer/Base | | |
| | material layer/Adhesive layer | | |
| 6 | Hard coating layer/Base material layer/Wavelength filter | Δ | Comparative |
| | layer/Adhesive layer/Base material layer/Optical functional sheet | | example |
| | layer/Adhesive layer/Electromagnetic wave shielding layer/Base | | |
| | material layer/Adhesive layer | | |

Specifically, the optical sheet of the Example shown as No. 1 is as follows.

### (1) Preparation of Constitutional Composition of the Light-Transmissive Portion

As a light-curable oligomer, 14.5 parts by mass of bisphenol-A/propylene oxide 2 mole-adduct, 9.2 parts by mass of xylylene diisocyanate, and 10.0 parts by mass of 2-phenoxyethyl acrylate; and as urethanizing catalyst, 0.01 parts by mass of bismuth tri(2-ethylhexanoate) (50% 2-ethylhexanoic acid solution) were mixed and reacted at 80° C. for 5 hours. Then, 1.6 parts by mass of 2-hydroxyethyl acrylate was added thereto and reacted at 80° C. for 5 hours to obtain an urethane acrylate-based oligomer.

As light-curable monomers, 14.7 parts by mass of 9,9′-bis(4-hydroxyethyl)fluorene ethylene oxide-modified diacrylate, 46.7 parts by mass of phenoxyethyl acrylate, and 3.3 parts by mass of bisphenol-A/ethylene oxide 4 mole-adduct were added.

As a mold release agent, 0.2 parts by mass of a phosphate ester of tetradecanol-ethylene oxide 10 mole-adduct (monoester/diester=1/1 by mole ratio) was used.

As a photopolymerization initiator, 2.3 parts by mass of 1-hydroxycyclohexyl phenyl ketone (commodity name: “IRGACURE 184” manufactured by Ciba Speciality Chemicals) was used.

These were mixed and homogenized to obtain a composition constituting the light-transmissive portion.

### (2) First Base Material Layer

For the first base material layer, a PET film (“A4300” manufactured by Toyobo Co., Ltd., thickness: 100 μm) was used.

### (3) Adhesive Layer

The adhesive layer was obtained by mixing: 100 parts by mass of an acrylic resin adhesive (“SK dyne 2094” manufactured by Soken Chemical & Engineering Co., Ltd., solid content: 25.0 mass %, solvent: ethyl acetate and methylethyl ketone); 0.28 parts by mass of a crosslinking agent (“E-5XM”, “L-45” manufactured by Soken Chemical & Engineering Co., Ltd., solid content: 5.0 mass %); 0.25 parts by mass of 1,2,3-benzotriazole; 32 parts by mass of diluting solvent (toluene/methylethyl ketone/cyclohexanone=27.69 g/27.69 g/4.61 g).

### (4) Formation of Light-Transmissive Portion

The light-transmissive portion was formed by feeding the composition constituting the light-absorbing portion of the step (1) into an inverted shape of the light-transmissive portion, which was formed on the surface of the molding roll. In the surface of the molding roll, grooves having a shape corresponding to the light-transmissive portion were formed in the circumferential direction. In the cross section of the direction orthogonal to the longitudinal direction of the grooves, each of the groove of the mode of the invention was a trapezoid having a groove's opening width of the outer circumferential side of the roll: 47 μm, a width of groove's bottom of the roll: 41 μm, and a depth of the groove: 69 μm; and the grooves were formed periodically at a pitch of 51 μm.

The above PET film was fed in between the molding roll and the nip roll. With the feeding of the PET film, the composition constituting the light-transmissive portion obtained in the step (1) was supplied on the PET film from the supplying apparatus and the light-transmissive portion was formed on the PET film by the pressure between the molding roll and the nip roll.

Then, by irradiating ultraviolet of 800 mJ/cm² by high-pressure mercury vapor lamp from the PET film side to cure the composition constituting the light-transmissive portion and releasing the light-transmissive portion from the molding roll by using mold-releasing nip, a sheet (i.e. an intermediate member) containing the light-transmissive portions and having a thickness of 252±20 μm was formed.

When measuring the refractive index at 589 nm using a Multiwavelength Abbe Refractometer (“DR-M4” manufactured by Atago Co., Ltd.), it was 1.570.

### (5) Preparation of the Composition Constituting the Light-Absorbing Portion

As light-curable oligomers, 20.0 parts by mass of oxirane, 2,2′-[(1-methylethylidene) bis(4,1-phenyleneoxymethylene)] bis-, homopolymer, 2-propenoate(epoxy acrylate oligomer) was used.

As a light-curable monomer, 20.0 parts by mass of 2-phenoxyethyl acrylate, 20.0 parts by mass of α-acryloyl-ω-phenoxy poly(oxyethylene), and 13.0 parts by mass of 2-{2-[2-(acryloyloxy)(methyl)ethoxy](methyl)ethoxy}(methyl) ethyl acrylate were mixed.

As a light-absorbing particle, 20.0 parts by mass of acrylic cross-linked particulate (manufactured by Ganz Chemical Co., Ltd.) containing 25% carbon black having an average diameter of 4.0 μm.

As a photopolymerization initiator, 7 parts by mass of 1-hydroxycyclohexyl phenyl ketone (“IRGACURE 184” manufactured by Ciba Speciality Chemicals).

These were mixed and homogenized to obtain the composition constituting the light-absorbing portion.

### (6) Formation of the Light-Absorbing Portion

The composition constituting the light-absorbing portion obtained in the step (5) was provided in a form of layer with a thickness of 100 μm from the supplying apparatus to the intermediate member formed in the step (4). Then, by using a doctor-blade, the composition constituting the light-absorbing portion provided on the intermediate member was filled in substantially V-shape grooves formed in the intermediate member (grooves between the light-transmissive portion) and excessive amount of the composition constituting the light-absorbing portion was strickled. Then, by irradiating ultraviolet of 800 mJ/cm² by high-pressure mercury vapor lamp to cure the composition constituting the light-absorbing portion, the light-absorbing portions were formed. When measuring the refractive index at 589 nm using a Multiwavelength Abbe Refractometer (“DR-M4” manufactured by Atago Co., Ltd.), it was 1.547.

### (7) Preparation of the Composition Constituting the Hard Coating Layer

As a transparent resin, PETA (pentaerythritol triacrylate), DPHA (dipentaerythritol hexaacrylate), and PMMA (poly(methyl methacrylate)) were mixed at a mass ratio of 86/5/9. Then, to 100 parts by mass of the transparent resin, 190 parts by mass of a mixed solvent of toluene (b.p. 110° C.) and cyclohexanone (b.p. 156° C.) (at amass ratio of 7:3) as the solvent were added to obtain a resin composition.

### (8) Formation of the Hard Coating Layer

On the sheet in which the light-absorbing portions were formed in the step (6), the composition constituting the hard coating layer obtained in the step (7) was coated; then, dried air at 70° C. was circulated at a flow rate of 12 m/min and the composition was dried for 1 minute. After that, the transparent resin was cured by irradiating ultraviolet (200 mJ/cm² in a nitrogen atmosphere). The thickness was 10 μm. When measuring the refractive index at 589 nm of the composition using a Multiwavelength Abbe Refractometer (“DR-M4” manufactured by Atago Co., Ltd.), it was 1.510.

### (9) Formation of the Electromagnetic Wave Shielding Layer

To the double-sided adhesive PET sheet (“COSMO SHINE A-4300” manufactured by Toyobo Co., Ltd., thickness: 100 μm) as the second base material layer, a light-curable resin composition for a primer layer was coated with a thickness of 5 μm by reverse gravure coating. As the light-curable resin composition, a mixture of: 35 parts by mass of epoxy acrylate prepolymer; 12 parts by mass of urethane acrylate prepolymer; 44 parts by mass of mono-functional acrylate monomer consisting of 2-phenoxyethyl acrylate; 9 parts by mass of tri-functional acrylate monomer consisting of ethylene oxide-modified isocyanuric acid triacrylate; and 3 parts by mass of 1-hydroxycyclohexyl phenyl ketone (“IRGACURE 184” manufactured by Ciba Speciality Chemicals) as a photoinitiator was used.

Next, the double-sided adhesive PET sheet on which a primer layer was formed was provided to an intaglio roll used for transferring step. Prior to it, a conductive composition was coated by using pickup roll on the depressed surface of the intaglio roll where recess portion is formed to make a lattice mesh pattern having a line width of opening: 20 μm, a line pitch: 300 μm, and a depth of recess: 20 μm; and the conductive composition outside the recess portion was strickled by using doctor-blade to fill the conductive composition only in the recess portion. The PET sheet (film) on which a primer layer was formed was fed in between the nip roll and the intaglio roll of which recess portion is filled with the conductive composition. By the pressure (biasing force) of the nip roll against the intaglio roll, the primer layer was transferred into the recess filled with the conductive composition. Then, the conductive composition and the primer layer were tightly adhered each other without making gap, and a part of the primer was made permeate into the conductive composition in the recess portion.

The conductive composition was produced in accordance with the following method. That is, 90 parts by mass of scale-type silver powder having an average diameter of about 2 μm as conductive powder; 3 parts by mass of acetylene black having an average diameter of 35 nm as carbon black; and 7 parts by mass of thermoplastic polyester urethane resin as a binder resin; and 35 parts by mass of butylcarbitol acetate as solvent were mixed; these were sufficiently stirred and then kneaded with three-roll mill.

Then, the following transfer was carried out. Firstly, the double-sided adhesive PET sheet on which a primer layer was formed was nipped between the intaglio roll and the nip roll so that the primer layer faces the depressed surface side of the intaglio roll. Between the intaglio roll and the nip roll, the primer layer of the double-sided adhesive PET sheet was thrusted against the depressed surface. Since the primer layer has fluidity, the primer layer which was thrusted against the depressed surface entered into the recess portion in which the conductive composition was filled, and even filled in the recess produced by the conductive composition in the recess portion. Hence, the primer layer was tightly adhered to the conductive composition. Then, when the intaglio roll rotated, ultraviolet was irradiated by a UV lamp consisting of high-pressure mercury vapor lamp and the primer layer made of the light-curable resin composition was cured. Due to curing of the primer, the conductive composition in the recess portion of the intaglio roll was tightly adhered to the primer layer. After that, the film was separated from the intaglio roll by the exit side nip roll; and a conductive composition layer was transferred on the primer layer. The transferred film thus obtained was passed through a drying zone at 110° C. to evaporate the solvent of the silver paste and solidify the paste, and a conductive layer consisting of a mesh pattern was formed on the primer layer. The thickness of the pattern portion in which the conductive layer existed (the gap between the thickness of mesh pattern portion in which the conductive layer was formed and thickness of the other part) was about 19 μm; the mesh pattern was transferred with almost the same thickness as the depth of the intaglio roll.

### (10) Formation of the Wavelength Filter Layer

A composition obtained by mixing: 120.0 parts by mass of acrylic resin (adhesive, “PTR-2500T” manufactured by Nippon Kayaku Co., Ltd.); 1.0 parts by mass of near-infrared ray absorbing dye (“IRG 068” manufactured by Nippon Kayaku Co., Ltd.); and 0.1 parts by mass of neon line absorbing dye (“TAP-2” manufactured by Yamada Chemical Co., Ltd.) was applied with a thickness of 25 μm on a mold release film (“E 7007” manufactured by Toyobo Co., Ltd., thickness: 38 μm) by die coater. Then, the coating was dried at 80° C. for 1 hour.

The optical sheet described in Example No. 2 is the optical sheet of Example No. 1 in which two layers of the same hard coating layers are laminated.

Accordingly, the refractive indices of the two hard coating layers are the same; when measuring the refractive index at 589 nm of these layers with a Multiwavelength Abbe Refractometer (“DR-M4” manufactured by Atago Co., Ltd.), it was 1.510.

The optical sheet described in Example No. 3 is basically the same as those of Examples No. 1 and No. 2. However, since the refractive index of the first base material layer was 1.570, refractive index of the hard coating layer was adjusted to become the same (i.e. 1.570). It will be described in detail as follows.

In 439 g of a mixed solvent of methylethyl ketone and cyclohexanone at a ratio of 50/50 mass %, 187.5 g of a mixture of dipentaerythritol pentaacrylate and dipentaerythritol hexaacrylate (DPHA, manufactured by Nippon Kayaku Co., Ltd.) and 62.5 g of bis(4-methacryloylthiophenyl)sulfide (MPSMA, manufactured by Sumitomo Seika Chemicals Co., Ltd.) were dissolved. Then, to the obtained solution, a solution obtained by dissolving 6.25 g of a photopolymerization initiator (“IRGACURE 907” manufactured by Nihon Ciba-Geigy K.K.) and 4.0 g of a photosensitizer (“KAYAKURE DETX” manufactured by Nippon Kayaku Co., Ltd.) in 49 g of methylethyl ketone was added.

When measuring, with a Multiwavelength Abbe Refractometer (“DR-M4” manufactured by Atago Co., Ltd.), the refractive index at 589 nm of the hard coating layer obtained by coating the solution and cured with ultraviolet, it was 1.570.

With respect to the Comparative examples shown as No. 4-6, many layers were laminated on the observer side of the optical functional sheet layer and these laminated layers had different refractive index from each other.

Evaluation of the contrast was performed as follows. Black-and-white pattern was displayed in the optical sheet-mounted display device; a contrast in a case with no external light entering into the display device was defined as a contrast in a darkroom and a contrast in a case with irradiation of an external light was defined as a contrast in a bright room. The contrast in the darkroom and the contrast in the bright room were visually observed and deterioration of the contrast in the bright room from the contrast in the darkroom was visually evaluated. Good results were shown by “◯” and the result substantially the same as the conventional one was shown by “X”. The results which were slightly better than that of the conventional ones were shown by “Δ”. The results are shown in Table 1.

As seen from Table 1, when many layers are laminated on the observer side of the optical functional sheet layer, the contrast is substantially the same as that of the conventional one. On the other hand, Examples of the present invention show better contrast compared with that of the conventional one.

The above has described the present invention associated with the most practical and preferred embodiments thereof. However, the invention is not limited to the embodiments disclosed in the specification. Thus, the invention can be appropriately varied as long as the variation is not contrary to the subject substance and conception of the invention which can be read out from the claims and the whole contents of the specification. It should be understood that display device with such an alternation are included in the technical scope of the invention.

What is claimed is:

1. A display device comprising: an image light source; and an optical sheet having a plurality of layers for controlling an incident light from the image light source and for outputting the light to the observer side,
wherein the optical sheet comprises an optical functional sheet layer in which light-transmissive portion(s) configured to transmit light and light-absorbing portion(s) configured to absorb light are alternately arranged along the sheet plane, and only one layer is provided on the observer side of the optical functional sheet layer.

2. The display device according to claim 1, wherein refractive index of the layer laminated on the observer side of the optical functional sheet layer is substantially the same as that of the light-transmissive portion of the optical functional sheet layer.

3. The display device according to claim 1, wherein the layer provided on the observer side of the optical functional sheet layer is a hard coating layer.

4. The display device according to claim 1, wherein the refractive index of the layer laminated on the observer side of the optical functional sheet layer is substantially the same as that of the light-transmissive portion of the optical functional sheet layer, and the layer provided on the observer side of the optical functional sheet layer is a hard coating layer.

5. A display device comprising: an image light source; and an optical sheet having a plurality of layers for controlling an incident light from the image light source and for outputting the light to the observer side,
wherein the optical sheet comprises an optical functional sheet layer in which light-transmissive portion(s) configured to transmit light and light-absorbing portion(s) configured to absorb light are alternately arranged along the sheet plane,
at least two layers are provided on the observer side of the optical functional sheet layer, and
refractive indices of the layers laminated on the observer side of the optical functional sheet layer are substantially the same.

6. The display device according to claim 5, wherein the refractive indices of the layers laminated on the observer side of the optical functional sheet layer are substantially the same as that of the light-transmissive portion of the optical functional sheet layer.

7. The display device according to claim 5, wherein the layers provided on the observer side of the optical functional sheet layer include at least one hard coating layer.

8. The display device according to claim 5, wherein the refractive indices of the layers laminated on the observer side of the optical functional sheet layer are substantially the same as that of the light-transmissive portion of the optical functional sheet layer, and the layers provided on the observer side of the optical functional sheet layer include at least one hard coating layer.
